(19) United States
(12) Patent Application Publication
(10) Pub. No.: US 2010/0212464 A1
(43) Pub. Date: Aug. 26, 2010

(54) WEB CORRECTION CUTTER

(75) Inventor: William J. Slyne, Markham (CA)

Correspondence Address: Thomas, Raring, & Teague, P.C., 536 GRANITE AVENUE, RICHMOND, VA, 23226, US

(73) Assignee: North Cutting Systems, LLC, Milford, CT (US)

(21) Appl. No.: 12/681,236

(22) PCT Filed: Oct. 23, 2008
(86) PCT No.: PCT/CA08/01877

§ 371 Date: Apr. 1, 2010

Related U.S. Application Data
(60) Provisional application No. 60/982,181, filed on Oct. 24, 2007.

(51) Int. Cl. B26D 5/02; B26D 7/01; B26D 7/20

(52) U.S. Cl. 83/13; 83/73; 83/659; 83/365

(57) ABSTRACT

A method and apparatus provide for continuous automatic cutting of a web of material wherein the web has a web anomaly that prevents the web from lying flat and straight. The web anomalies include when a web has a non-zero Gaussian curvature and/or when the web or roll of material follows an arc when the roll is unrolled onto a flat surface. These web anomalies may be justified through use of computer controlled cutters that correct the motion trajectory of the cutter relative to the web and also by means of distortions to the support surface upon which the cutting of the web is to occur.

This application claims the benefit of U.S. Provisional Application No. 60/982,181, filed Oct. 24, 2007, which is incorporated herein by reference.

A method and apparatus are disclosed that provide for continuous automatic cutting of webs of flexible material where the web has either nearly constant non-zero Gaussian Curvature in the machine direction and/or where the web or roll of material follows an arc when the roll is unrolled on to a flat surface. The method and apparatus provides for the nullification of these web anomalies by means of computer controlled corrections to the motion trajectories of the cutting means relative to the web and by means of computer or manually controlled distortions to the support surface upon which said cutting of said web is to occur.

### BACKGROUND

Continuous automatic cutting of webs of flexible material is known and widely practiced. These cutting systems typically include rolls of flexible web material that may be unrolled onto a flat cutting surface. Alternatively, the flexible web may be cut on the surface of a cutting cylinder that the web passes over after being unrolled. If the web is flat and has straight and parallel edges, then there should be no difficulty or problem with cutting. However, a web of flexible material may have a curve formed in it or non-zero Gaussian curvature formed within it during manufacture, typically during weaving, laminating or thermal forming processes. This curvature creates difficulties during the cutting of pieces from the web of material.

### BRIEF DESCRIPTION OF DRAWINGS

FIG. 1 is a perspective view of a roll of flexible web material with a portion of the web material pulled from the roll.

FIGS. 1A-1D are drawings of web pieces that are laid flat and straight on a flat surface.

FIGS. 2A-2D are drawings of the web pieces shown in FIGS. 1A-1D with the web piece cut down a mid line of each web piece and then allowed to day flat.

FIGS. 3A-3C are three dimensional views of alternative flexible webs having various curvatures. FIG. 4 is an example of a pattern piece of web material cut from a web.

FIGS. 4A-4F are pattern pieces cut from various webs having various curvatures.

FIGS. 5A-5C illustrate a cutting cylinder with a web of material passing over the surface of the cutting cylinder.

FIGS. 6A-6D illustrate various cutting cylinders having alternative, varying diameters.

### DETAILED DESCRIPTION

As explained, webs of flexible material, and in particular rolled webs of flexible material, are traditionally cut and handled on the assumption that they are completely flat and have sides/edges that are parallel when laid onto a flat surface. The realities are, however, that these webs may include anomalies therein that result in curvatures in the web when it is laid flat. If ignored, these anomalies can result in the cut pieces from the web being inaccurate as compared with cut pieces from a flat and straight web. In order to compensate for this curvature, as described herein, corrections to the cutting motion of a cutter relative to the web, optionally combined with a distortion to the support surface on which the web is to be cut, will compensate for and correct the web anomaly.

### Web Examples and Web Anomalies

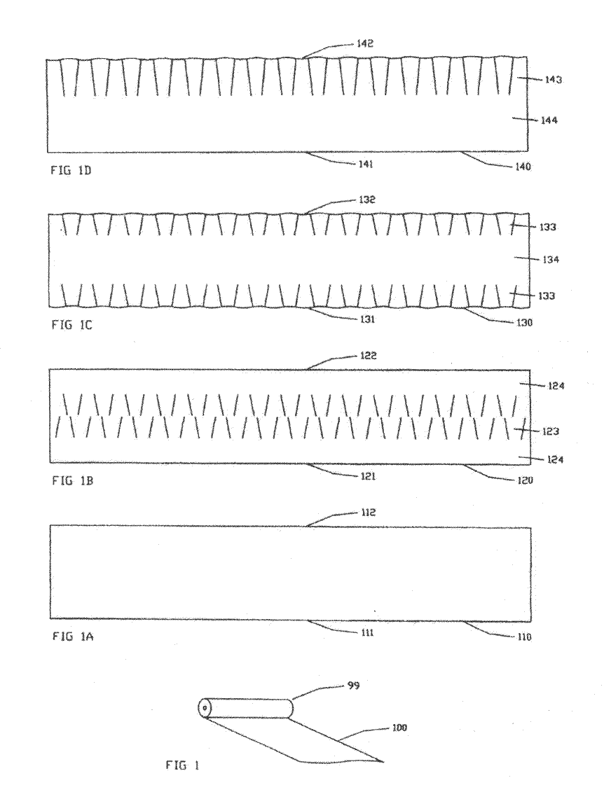

FIG. 1 shows a roll 99 of flexible material with a portion 100 pulled out from the roll.

FIG. 1A shows a rectangular portion 110 of a flat web in plan view. This example piece is 60″ wide by 310″ long. Web piece 110 is an example of a flat, straight material where at all points on the web piece 110 the Gaussian Curvature is substantially zero, and both edges 111 and 112 have substantially zero Geodesic Curvature and are substantially parallel. The web piece 110 lays flat and straight on a flat surface and does not exhibit any wrinkles or experience internal strains. A top plan view (as in FIG. 1A) will be used henceforth where the flexible material is essentially two dimensional and extends in the two dimensions in the plane of the figure (in the plane of the page), and has substantially insignificant thickness normal to the plane of the figure (normal to the plane of the page).

Examples of flexible web materials range from nanostructured membranes in the tens of nanometers thick up to 0.040″ thick plasticized PVC, and perhaps somewhat thicker. Flexible materials can be constructed of generally homogenous films, anisotropic films, reinforced composite films, flexible composite membranes, woven fabrics, thin metallic films and sheets and numerous combinations of the aforementioned materials. Although roll goods or webs are to be discussed for the purposes of illustration, the disclosed invention is intended to cut and draw all types of flat pieces of flexible material including animal hides.

FIG. 1B shows a web piece 120 that exhibits wrinkles 123 down the center of the web and flat bands 124 along and adjacent to the two edges 121 and 122, when web piece 120 is unrolled onto a flat surface with the lower edge 121 aligned parallel and straight with the edge of the surface.

FIG. 1C shows a web piece 130 that exhibits wrinkles 133 down the two edges of the web and a flat band 134 down the center of the web, when web piece 130 is unrolled onto a flat surface with the lower edge 131 aligned parallel and straight with the edge of the surface.

FIG. 1D Shows a web piece 140 that exhibits wrinkles 143 adjacent to the top edge 142 of the web and a flat band 144 adjacent to the lower edge 141 of the web, when web piece 140 is unrolled onto a flat surface with the lower edge 141 aligned parallel and straight with the edge of the surface.

Web pieces 120, 130 and 140 have been illustrated with flexible web anomaly symptoms that are quite apparent. While it is common that webs will have these anomalies, the anomaly may not be apparent until pattern pieces are cut from the web and/or when the web is exhibiting difficulty in feeding into an automatic conveyer cutter.

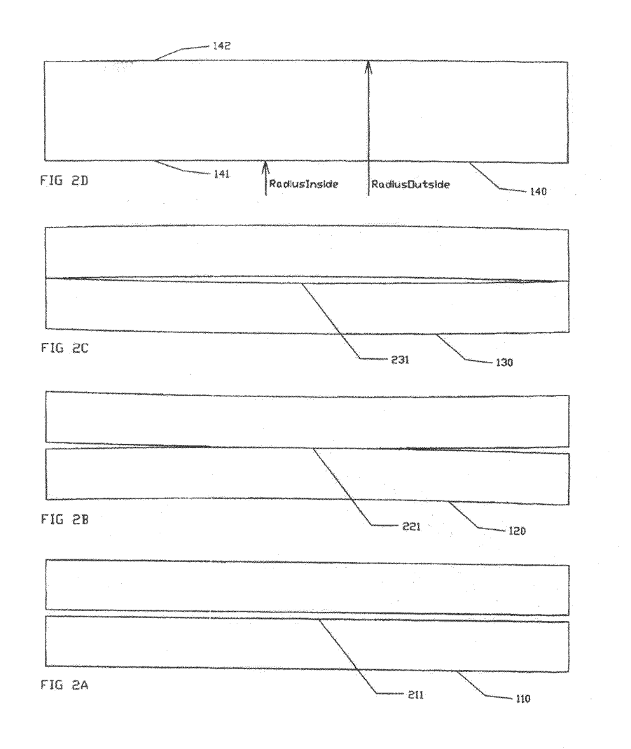

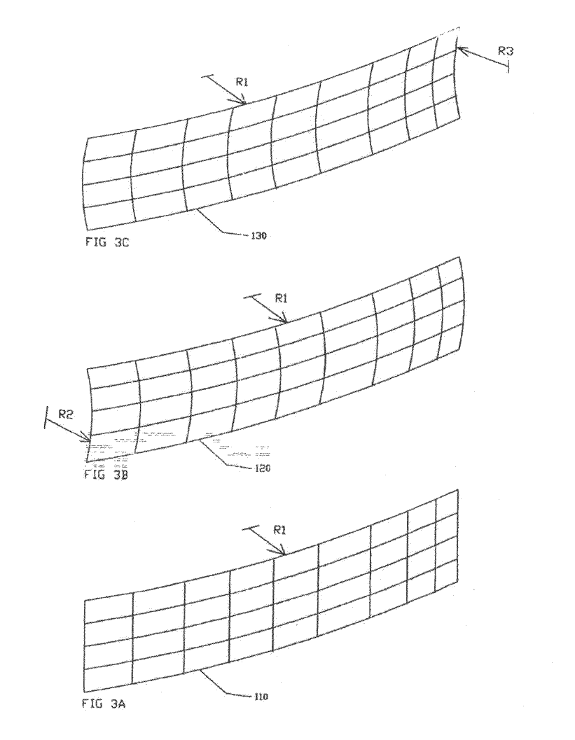

FIG. 2A shows web piece 110 after it has been cut in two down the midline of the web piece. The two pieces have been separated by a 4″ gap 211. Since the original web piece 110 is flat, the two severed web pieces should also remain flat and straight.

FIG. 2B shows web piece 120 after it has been cut in half down the midline of the web piece. The two pieces lay flat but curve away from each other, starting out in contact with each other then curving away until they are separated at the ends by a 4″ gap 221. The original web piece 120 had wrinkles down the center and the edges were flat. This implies that there is excess material down the center compared to the edges and this extra material allows the two pieces to bow as shown in FIG. 2B.

FIG. 2C shows web piece 130 after it has been cut in two down the midline of the web piece. The two resultant pieces have been laid down in contact at the ends but have a gap 231 of 4″ in the center. The original web piece 130 had wrinkles adjacent to the two edges while the center was flat. This implies that there is excess material down the two edges compared to the center and this extra material allows the two pieces to bow as shown in FIG. 2C.

FIG. 2D shows the web piece 140 where the piece is allowed to lay flat. The wrinkles visible in FIG. 1D when the lower edge 141 of the web was forced to be straight, have disappeared (as have the internal strains) since the web piece has taken it true form, that form being a shallow arc. If the material lays flat without wrinkles the centers of curvature for edge 141 and edge 142 will converge at the same point.

Web behavior as illustrated in FIGS. 1B through FIGS. 1D and FIGS. 2B through FIGS. 2D are common and often persist for the entire roll and in some cases the entire lot of a web material due to the fact that the production process variables were constant during the manufacture of the roll or lot.

FIG. 3A shows a web piece 110 in a three dimensional view. Since this web is flexible it is presented with a slight curvature R1 and with no applied strains in order to show that there is no curvature in the transverse (cross web) direction. The correct physical interpretation of this form is that the surface has zero Gaussian Curvature. Such a web can be laid flat on to a flat cutting surface or cut with a conveyer cutter without causing distortions in the resultant cut pieces.

FIG. 3B show web piece 120 in a three dimensional view. The symptoms visible in FIG. 1B and FIG. 2B are indicative of a surface with non-zero Geodesic Curvature. In FIG. 3B R1 of web piece 120 is the same as R1 of web piece 110, since web piece 120 has curvature R2 in the cross web direction web piece 120 exhibits complex curvature where R1 and R2 are the principle surface normal curvatures. The Gaussian Curvature is positive as indicated by R1 and R2 being on the same side of the web piece.

FIG. 3C shows web piece 130 in a three dimensional view. The symptoms visible in FIG. 1C and FIG. 2C are indicative of a surface with non-zero Geodesic Curvature. In FIG. 3C R1 of web piece 130 is the same as R1 of web piece 110, since web piece 130 has curvature R3 in the cross web direction web piece 130 exhibits complex curvature where R1 and R3 are the principle surface normal curvatures. The Gaussian Curvature is negative as indicated by R1 and R3 being on opposite sides of the web piece.

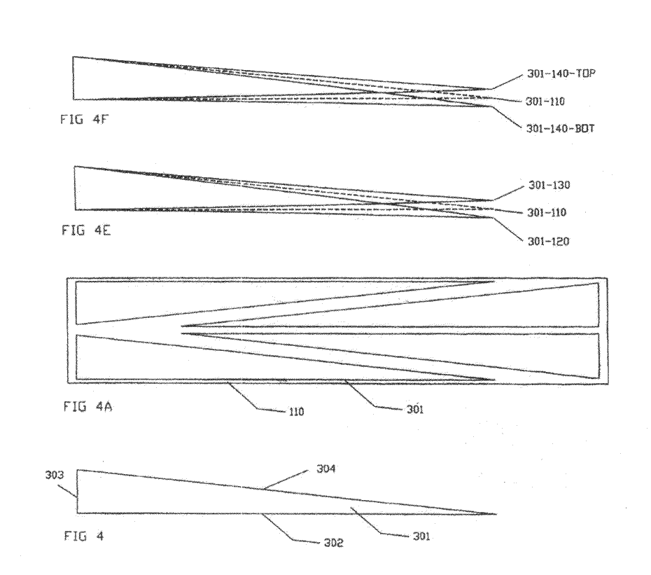

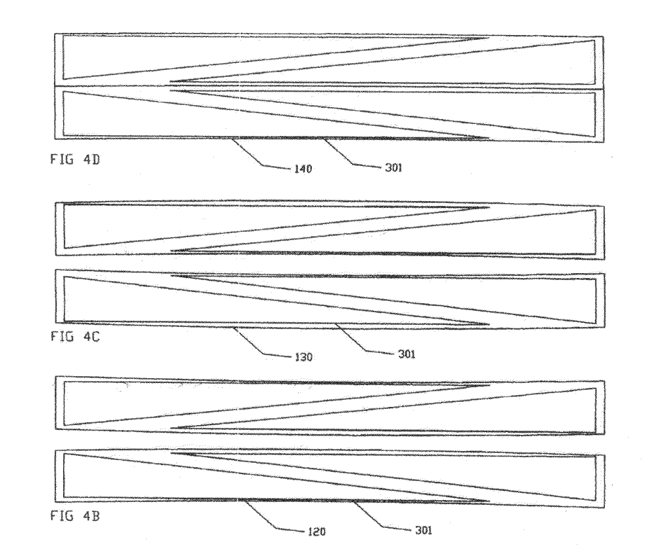

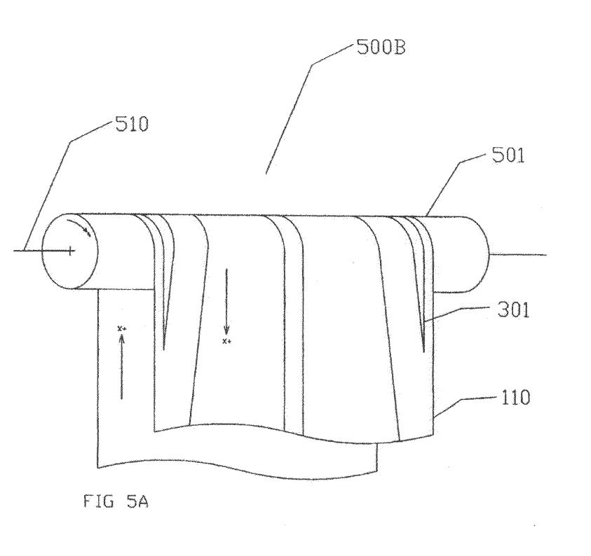

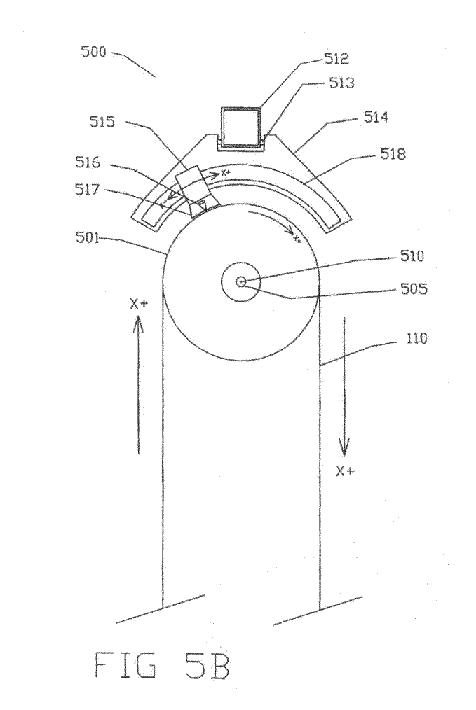

FIG. 4 is the example pattern piece 301 to be cut which is a right angle triangle with a base 302 of 240″, a height 303 of 25″ and an hypotenuse 304 of 241.3″. It is desired that the base be aligned as closely parallel to the web edge as possible. Pattern piece 301 is quite simple, consisting of just three straight line segments.

FIG. 4A shows four copies of the same pattern piece 301 nested within the web piece 110. It is expected that prior art cutting methods would cut the four examples of pattern piece 301 properly resulting in cut pieces whose dimensions are substantially equivalent to the dimensions provided to the cutting machine.

FIG. 4E and FIG. 4F show the result of cutting the pattern piece 301 from the various web pieces thus far illustrated. Pattern piece 301-110 (dashed lines) is pattern piece 301 cut from web piece 110 correctly since web piece 110 is flat and straight. The other cut pattern pieces are overlaid on 301 to illustrate the distortions that manifest themselves once the pattern piece 301 is cut from the various web pieces with intrinsic distortions.

Pattern piece 301-120 is cut from web piece 120, pattern piece 301-130 is cut from web piece 130, pattern piece 301-140-BOT is cut from web piece 140 nested against the top edge 142, and pattern piece 301-140-TOP is cut from web piece 140 nested against the bottom edge 141.

In general most pattern pieces are to be joined to other cut pattern pieces to yield a two dimensional or a three dimensional flexible article. Therefore, any distortions in the cut pattern pieces will propagate when joined resulting in a finished article with incorrect dimensions. Further, the distortions in the pattern pieces may compromise or make impossible the process of joining the pattern pieces together.

There is a prior art technique that can be utilized to reduce some of the distortion produced by cutting from webs 120, 130 and 140. This technique requires 1) the utilization of a static surface cutting machine with a surface as long as the longest piece that needs to be cut, 2) that the operator layout the web piece from which the pattern piece is to be cut, 3) the operator then splits the web pieces 120 and 130 allowing the resultant split webs to closely lay flat on the cutting surface, although they and web piece 140 will now lay on the surface with a curved edge. However, the following are significant drawbacks of this technique:

the technique is not relevant if the pattern piece is the full width of the web piece,

the technique is extremely labor intensive and time consuming,

the process and location of splitting the web is subjective,

the slitting of the web may require re-nesting and/or re-lofting the pattern pieces,

the technique does not fully correct the cause of cut pattern piece distortion.

FIG. 4B, FIG. 4C and FIG. 4D show the resultant web pieces and the newly nested pattern pieces. It is apparent that the pattern pieces are now pushed closer to the edge of the web and except for pattern pieces cut from web piece 140, the pattern pieces will still result in some measure of the distortions illustrated in FIG. 4E.

In the case of automatic web cutting systems that automatically pull web material from a roll and advance the web over a circuitous cutting surface such as a conveyer cutter or a drum cutter as are known in the prior art, the distortions elaborated upon here cannot be removed or reduced. Although specific web pieces and specific pattern pieces have been utilized to illustrate these concepts, it is contemplated that as in the prior art, the disclosed invention could be utilized to cut a variety of flexible materials each material potentially with variety of supplied shapes and sizes. Further, cutting and slitting operations are also potential utilities of the disclosed invention. Lastly, although the utility of the disclosed invention has been articulated with regard to cutting of web pieces with intrinsic distortions, the disclosed invention suffers no loss of utility when utilized to cut web pieces that do not have intrinsic distortions.

### Description of Preferred Embodiment

The disclosed invention may have some or all of the following components:

1. A web distortion measurement system. Either manual or automatic.

2. A web distortion calculation and compensation method performed manually or implemented in software. These compensations are supplied to adjust the cut/draw coordinates and the geometry of the cutting surface.

3. An adjustable or changeable cutting surface that provides a variety of surface geometries where such geometries compensate for web distortions allowing for the continuous cutting of unstrained flexible materials. Although a generally cylindrical cutter will be elaborated upon, it has been contemplated that a deformable conveyer cutting surface or conveyer cutting surface support could be fabricated to perform the same function where the resultant cutting surface must be able to have complex curvature.

4. An articulated cutting means able to cut over a portion of the adjustable or changeable cutting surface while the cutting surface is either in motion or held stationary, said cutting means having its height and surface normal orientation to the

cutting surface automatically adjusted as necessary while traversing the cutting surface.

### Measurement of the Web Distortion & Cutting Surface Compensation Calculations

The two example calculations below are intentionally simplified. However, numerous methods are available and more complex curvature distributions would result in more complex cutting surface profiles.

1 Example calculations will be presented for the case illustrated in FIG. 2B:

(L) Web Piece Length=310 inches

(W) Web piece width=60 inches

(C) Camber depth=½ of gap at either end=2 inches

(Rc) Radius of curve of edge of half web piece—R=C/2+L̂2/(8×C)
Rc=6007 inches

(D) Edge Length Differential=(WebWidth/2)/Radius of Curvature
D=30.0/6007
D=0.00499

(Rs) Radius of sphere that this web has the same Gaussian Curvature
Rs=SQRT ((webwidth/2.0)̂2/(1−(1−0.00499)̂2))
Rs=300.55 inches

(G) Gaussian Curvature=1/Rs×1/Rs
G=0.00001107

Resultant Cutter Cylinder mid camber (Delta R)=0.040″

This result requires that for a 60″ wide web with the intrinsic distortion measured in FIG. 2B that if we use a nominal 16.00 inch diameter roller, the mid point of the roller will need a diameter of 16.08 inches to support the web without imparting strains.

2 Example calculations will be presented for the case illustrated in FIG. 2D:

(L) Web Piece Length=310 inches

(W) Web piece width=60 inches

(C) Camber depth measured at bottom edge=4 inches

(RI) Radius Inside of edge of web piece—R=C/2+L̂2/(8×C)
Radius Inside=RI=3005 inches

(RO) Implied Radius Outside of edge of web piece—RO=RI+W
Radius Outside=RO=3065 inches

(RM) Implied Radius of mid line of web piece—RM=(RI+RO)/2
Radius mid web=RM=3035 inches

The quantitative implication from this is that the lower web edge in FIG. 2D is 1% shorter than the web mid line, and the upper web edge in FIG. 2D is 1% longer than the web mid line.

This result requires that for a 60″ wide web with the intrinsic distortion as measured from FIG. 2D and using a nominal 16.00 inch diameter roller, the roller edge supporting the inside edge of the web will have a radius 1% smaller than the radius of the roller supporting the web mid line, and similarly the roller edge supporting the web outside edge will have a radius 1% greater than the radius of the roller supporting the web mid line:

Roller lower Radius=7.920″

Roller middle Radius=8.000″

Roller upper Radius=8.080″

### Web Cutting Machine

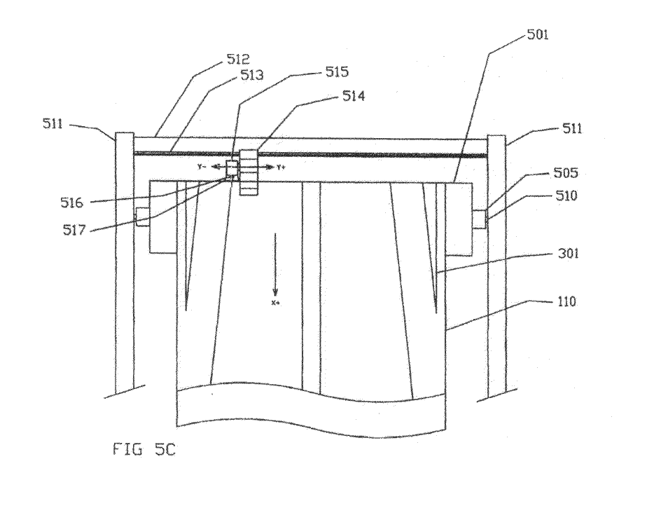

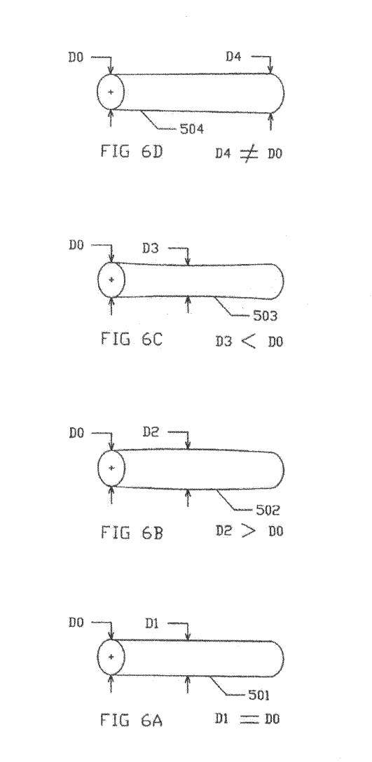

In FIG. 5A cutting system 500B is shown without the cutting means or the support structure and rails that position the cutting means. Illustrated are a constant diameter cylinder 501 that rotates on its axis 510 position controlled by a motor and encoder attached to a control computer (not shown). The example web piece 110 does not have any intrinsic distortions therefore 501 can cut pattern piece 301 essentially without any distortion on the constant diameter cylinder 110. FIG. 6A illustrates the constant diameter cutting cylinder 501 that would be utilized to cut web piece 110, the web piece without intrinsic distortion.

FIG. 6B illustrates the cutting cylinder 502 that would be utilized to cut web piece 120, the web piece with positive Gaussian Curvature. Since D2>D0, the extra material present in web piece 120 would be supported over D2 while the unwrinkled edges would be supported by D0.

FIG. 6C illustrates the cutting cylinder 503 that would be utilized to cut web piece 130, the web piece with negative Gaussian Curvature. Since D3<D0, the extra material present in web piece 130 would be supported over D0 while the unwrinkled middle would be supported by D3.

FIG. 6D illustrates the cutting cylinder 504 that would be utilized to cut web piece 140, the web piece with in plane curvature. Since D4>D0, the extra material present in web piece 140 would be supported over D4 while the unwrinkled edge would be supported by D0.

FIG. 5B and FIG. 5C illustrate the scheme of the disclosed cutting system. In this example the cutting cylinder 501 is shaped with D1=D0 for a flat web piece 110 without edge curvature.

The cutting cylinder 501 rotates about its axis 510 on shaft 505. Web 110 is wrapped around the top half of cutting cylinder 501 where it can be cut by laser or other cutting means, the laser beam focused onto the cutting surface by lens 516. The cutting cylinder is supported about a shaft 505, the shaft is allowed to rotate about the central axis 510 of the cutting cylinder 501 on bearings (not shown) which secured to a support frame 511. The support frame also secures the Y-axis cross beam 512. The Y-axis support beam supports the Y-axis rails 513. A Y-axis carriage 514 is able to traverse the entire length of the cutting cylinder 501 parallel to the rotation axis 510 of the cutting cylinder 501.

The Y-carriage 514 supports a curved X-axis rail 518. The curve of this rail is an arc with its center coincident with the center of the cutting cylinder. An X-carriage 515 is supported by the X-axis rail 518 and the X-carriage can move in an arc motion along this X-axis rail 518 maintaining an orientation normal to the surface of the cutting cylinder 501 and at a fixed distance from the axis of rotation 510 of the cutting cylinder.

In this example, the cutting means is a focused laser beam (not shown). The laser source normally used to cut non-metallic flexible webs is a CO2 laser in the power range from 50 watts to 250 watts. This source would emit a beam under computer control, the beam would be reflected by a series of mirrors in what is known a ‘flying optic’ arrangement, directing the laser beam energy to the lens while the two carriages X 515 and Y 514 move in coordination also by computer control.

The inside top half of the cutting cylinder may be in fluid communication with a vacuum pump (not shown) to restrain the web piece and evacuate cutting fumes from between the web and the cutting surface. In normal operation, the cutting cylinder advances the web piece by about ¼ of a turn of the cutting cylinder 501 in the X+ direction so that cutting carriage 515 can cut any part of the web piece by combining traversing motions along the X rail 518 and the Y rail 513. This ¼ of a turn of the cutting cylinder is normally called a frame. By advancing and then cutting the contents of each frame the cutter can address webs of essentially infinite lengths. Cut curves that extend beyond the boundaries where one frame contacts the next are cut in segments where the finished cut curve appears to be continuous.

The cutting cylinder motor is under the same computer control as are the laser beam source and the X axis and Y-axis motors providing for coordinated motion, web advance and coordinated laser cutting from a web on a continuous basis.

### Web Correction Support Surface

The cutting cylinder also allows for the computer to control the diameter of the cutting surface at least one location along the axis of rotation, and normally at a number of locations along the axis of rotation. This cutting surface variable diameter control is what allows for the proper support and alignment of any web being cut on the machine.

Examples of cutting cylinder profiles required to correct the basic intrinsic distortions illustrated in FIGS. 1B through FIGS. 1D are shown in FIGS. 6B through FIGS. 6D respectively. The specific apparatus utilized to perform the diametral adjustments is not elaborated upon herein. However, in the simplest form a number a permanently shaped generally cylindrical cutting drums are kept on hand and the appropriately shaped cylinder is used within the cutting system as the cutting surface to cut a specific roll of material that requires correction. The cutting cylinder having a curvature that generally corresponds to the curvature anomaly of the web of flexible material would be used. For flat undistorted webs a constant diameter cylinder is utilized.

Prior art cutting support surfaces are either flat planar surfaces or are cylindrical surfaces such as disclosed in U.S. Pat. No. 6,843,155. In all of these cases a web with non-zero Gaussian Curvature will not lay flat and any attempt to force a web to lay flat will induce stresses within the web. Such stresses may not be apparent until after the web has been cut and the originally straight features will relax into a curved segment of the web, where such a curved piece will not be of the desired dimensions or form.

The disclosed invention provides for a method and apparatus to support this web for cutting without imparting stresses within the web by advancing the web over and around a portion of the arc of a rotating roller that functions as a cutting support surface and where said roller can have its surface shape distorted such that the Gaussian Curvature of said roller's surface is the same as or generally corresponds to the Gaussian Curvature of the web at the locations where the web is in contact with the roller.

Cutting means well known to those skilled in the art of cutting flexible webs include, laser beam means, rolling blade means, drag knife means, reciprocating knife means, water jet cutting means, ultrasonic cutting means etc. Each type of cutting means utilized determines the nature of the surface of the roller. In all cases the surface must be able to support the forces imparted upon the roller by the cutting means and the vacuum force from within the roller. Example surfaces are: Perforated aluminum strips aligned axially for a laser, “bristle blocks” on axial aligned support strips for a reciprocating blade, PVC bars axially aligned for a rotating blade cutter, etc.

Since the disclosed invention utilizes a roller with a variable diameter across its width, the cutting means may also require an additional degree of freedom, that of conformance to the diameter of the roller at the point of cutter contact, normal to the surface of the roller.

While the present invention has been described in detail with reference to the preferred embodiments thereof, it should be understood to those skilled in the art that various changes, substitutions and alterations can be made hereto without departing from the scope of the invention as defined by the appended claims.

What is claimed is:

1. An apparatus for continuously cutting patterns from a flexible web of material wherein the web of material has a curvature anomaly when unrolled on a flat surface, the apparatus comprising:
a circuitous cutting surface and a movable cutter mounted adjacent the cutting surface for cutting a web of material that passes over the cutting surface;
wherein the cutter is fixed to a carriage, and the carriage is carried on both X and Y rails whereby the cutter is movable in both X and Y directions relative to the cutting surface; and
wherein the cutting surface has a curvature that generally corresponds to curvature anomaly of the web of material.

2. The apparatus described in claim 1, wherein the circuitous cutting surface comprises a cutting cylinder.

3. A kit comprising the apparatus described in claim 2, the kit further comprising a plurality of cutting cylinders, each cylinder having a different curvature than the other cylinder or cylinders; and
wherein, only one cylinder at a time is mounted adjacent to the cutter.

4. The apparatus described in claim 1, wherein the Y rail has a length that is substantially the same as the width of the cutting surface.

5. The apparatus described in claim 1, wherein the cutter comprises a laser.

6. The apparatus described in claim 2, wherein the cutting cylinder has a surface comprising perforations, and the cutting cylinder is hollow and the perforations are in fluid connection with the hollow portion defined by the cylinder.

7. The apparatus described in claim 1, wherein the curvature anomaly is a non-zero Gaussian curvature in the web.

8. The apparatus described in claim 1, wherein the curvature anomaly is that the web of material follows an arc when a roll of the web material is unrolled onto a flat surface.

9. A method for continuously cutting patterns from a flexible web of material wherein the web of material has a curvature anomaly with laid on a flat surface, the method comprising the steps of:
providing a web of flexible material, wherein the web has a curvature anomaly;
measuring the curvature anomaly of the web of flexible material;
providing a circuitous cutting surface for use in cutting the web of flexible material;
wherein the cutting surface has a curvature that generally corresponds to the curvature anomaly of the web of flexible material.

10. A method for continuously cutting patterns from a flexible web of material wherein the web of material has a curvature anomaly when laid on a flat surface, the method comprising the steps of:
providing a web of flexible material, wherein the web has a curvature anomaly;
measuring the curvature anomaly of the web of flexible material;
providing a circuitous cutting cylinder for use in cutting the web of flexible material;
wherein the cutting cylinder has a curvature that generally corresponds to the curvature anomaly of the web of flexible material.

11. A method as described in claim 10, further comprising the steps of:
providing a plurality of cutting cylinders, each having a different curvature, and
selecting the cutting cylinder for use with a specific web of flexible material, the cutting cylinder having the curvature closest to the curvature of the web of flexible material.

12. A method as described in claim 10, wherein the curvature anomaly is a non-zero Gaussian curvature in the web.

13. A method as described in claim 10, wherein the curvature anomaly is that the web of material follows an arc when a roll of the web material is unrolled onto a flat surface.
